(19) United States
(12) Patent Application Publication
(10) Pub. No.: US 2010/0019506 A1
(43) Pub. Date: Jan. 28, 2010

(54) Power system having an ammonia fueled engine

(75) Inventors: Weidong Gong, Dunlap, IL (US); Martin Leo Willi, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/219,418

(22) Filed: Jul. 22, 2008

(51) Int. Cl. F02B 63/04; F02B 43/00; F02D 41/00

(52) U.S. Cl. 290/1 A; 123/1 A; 123/672

(57) ABSTRACT

A power system is disclosed. The power system may include an output device and a combustion engine configured to combust ammonia as a primary fuel to generate mechanical power directed to the output device. The power system may also include an electrical unit configured to supplement the mechanical power directed to the output device.

### TECHNICAL FIELD

The present disclosure is directed to a power system and, more particularly, to a power system having an ammonia fueled engine.

### BACKGROUND

Increasing concerns on global warming have given impetus to the search for zero-carbon fuels for use in combustion engines. Characteristics of ammonia fuel, such as zero CO₂ emission, relatively high energy density, well-established production infrastructure, and competitive cost, have made ammonia an attractive alternative fuel for combustion engines. When ammonia is combusted, the combustion produces a flame with a relatively low propagation speed. In other words, the combustion rate of ammonia is low. This low combustion rate of ammonia causes combustion to be inconsistent under low engine load and/or high engine speed operating conditions. Most existing combustion engines that use ammonia as engine fuel typically require a combustion promoter (i.e., a second fuel such as gasoline, hydrogen, diesel, etc.) for ignition, operation at low engine loads and/or high engine speed. However, the requirement for the combustion promoter fuel fluctuates with varying engine loads and engine speed, which can cause control issues. Furthermore, the use of dual fuels generally requires dual fuel storage systems, dual delivery systems, and dual injection systems, thus adding additional weight, complexity, and cost to the engine system. To eliminate the use of combustion promoter fuel, combustion engines that burn ammonia alone as engine fuel have been explored.

One such combustion engine that burns only ammonia as a fuel is described in U.S. Pat. No. 3,455,282 (the '282 patent) issued to T. J. Pearsall on Sep. 25, 1967. The '282 patent describes a combustion engine having a substantially spherical combustion chamber for combusting ammonia alone as fuel. To ensure performance at low load conditions, the combustion engine uses highly compressed ammonia with a compression ratio of the order of 12:1 to 16:1. Due to the low rate of flame propagation, performance of the disclosed ammonia-fueled combustion engine decreases at engine speeds above 3000 r.p.m. As such, an added fuel such as hydrogen is still needed to improve performance at speeds above 3000 r.p.m.

Although the combustion engine of the '282 patent may seem promising in eliminating the need for combustion promoter fuel, such a combustion engine may still have limited applicability. In particular, the engine of the '282 patent may still perform poorly in applications where engine speeds are high without the use of a second fuel.

The power system of the present disclosure is directed toward improvements in the existing technology.

### SUMMARY

One aspect of the present disclosure is directed to a power system. The power system may include an output device and a combustion engine configured to combust ammonia as a primary fuel to generate mechanical power directed to the output device. The power system may also include an electrical unit configured to supplement the mechanical power directed to the output device.

Another aspect of the present disclosure is directed to a method of operating a power system. The method may include combusting ammonia as a primary fuel to generate mechanical power directed to drive the power system. The method may also include electrically supplementing the mechanical power directed to drive the power system.

### BRIEF DESCRIPTION OF THE DRAWINGS

FIG. 1 is a diagrammatic illustration of an exemplary disclosed machine; and

FIG. 2 is a schematic illustration of an exemplary disclosed power system that may be used with the machine of FIG. 1.

### DETAILED DESCRIPTION

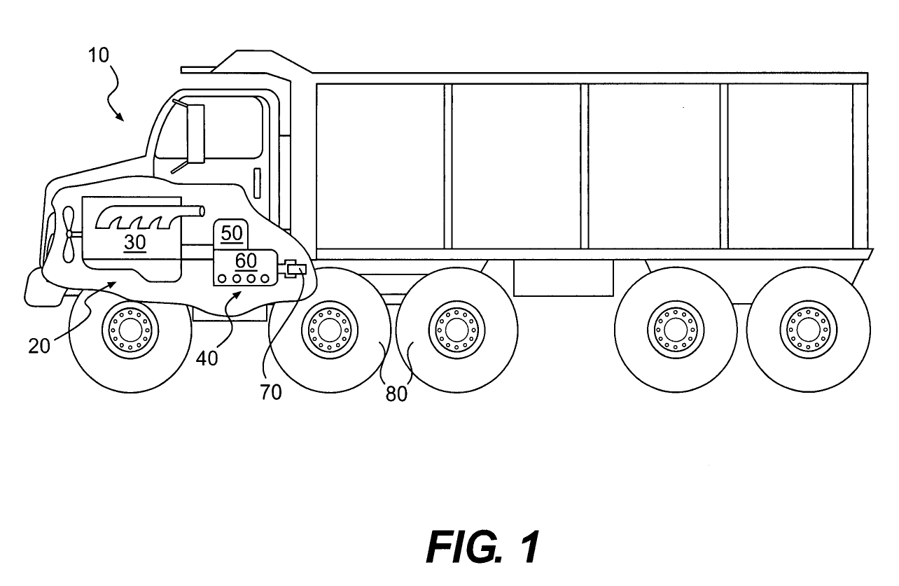

FIG. 1 diagrammatically illustrates an exemplary machine 10. Machine 10 may be a mobile machine such as a vehicle, or a stationary machine such as a pump, a power generator, etc. For illustrative purposes, machine 10 is schematically shown as a vehicle in FIG. 1.

Machine 10 may include a power system 20 configured to provide power to drive machine 10. Power system 20 may include a combustion engine 30 configured to combust ammonia as a primary fuel and produce mechanical power used to drive machine 10. For the purpose of this disclosure, a fuel may be regarded as a “primary” fuel if the fuel constitutes, for example, at least 80% of the total fuel directed into and combusted by combustion engine 30. In some embodiment, ammonia fuel may constitute 90%-95%, or even as high as 100% (ammonia being the only fuel) of the total fuel combusted by combustion engine 30. It is understood that the percentage used here may be based on mass, volume, or thermal energy of the fuel. The fuel directed into and combusted by combustion engine 30 may, in some situations, include additives, such as detergents, lubricants, ethanol, etc.

Machine 10 may also include a drivetrain 40 coupled to and driven by combustion engine 30. Drivetrain 40 may include a transmission 60 configured to receive the mechanical power produced by combustion engine 30 and to transmit the mechanical power to an output device 70, and an electrical unit 50 configured to convert a portion of the mechanical power produced by combustion engine 30 to electrical power selectively used to drive output device 70 during particular operating conditions. Output device 70 may be configured to output the mechanical power to drive a load 80. In the embodiment shown in FIG. 1, load 80 may be one or more traction devices configured to propel machine 10, for example, wheels.

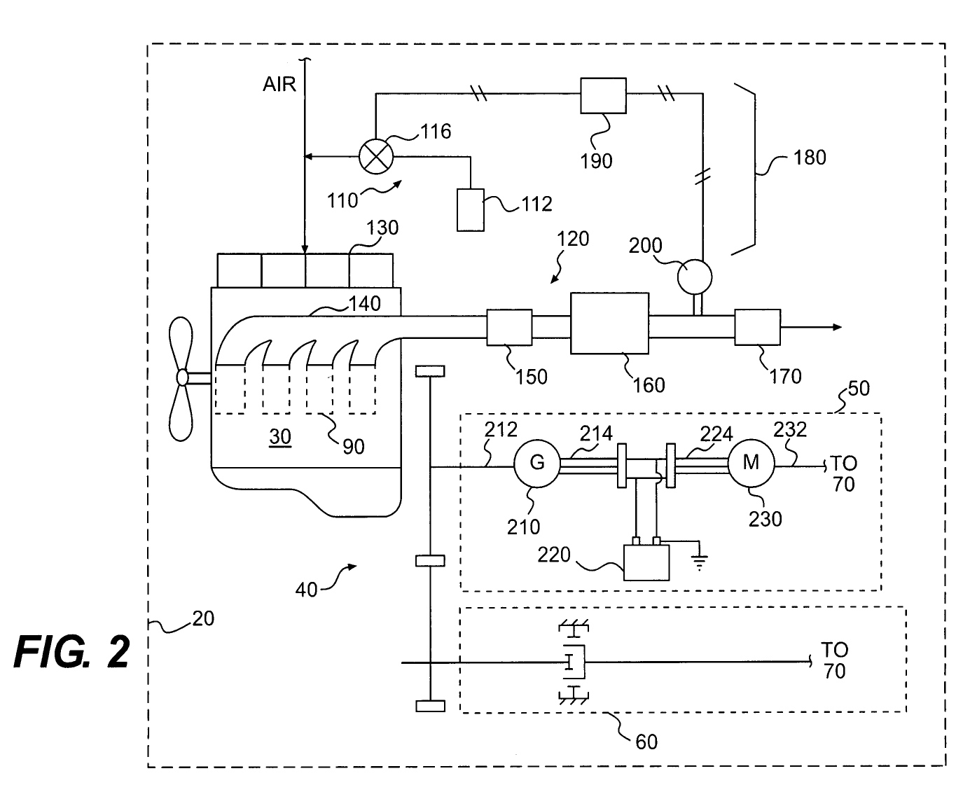

As shown in FIG. 2, combustion engine 30 may include one or more cylinders 90 at least partially defining one or more combustion chambers. Combustion engine 30 may also include a fuel supply system 110 configured to provide ammonia fuel to cylinders 90, and an exhaust system 120 configured to treat exhaust received from cylinders 90.

Fuel supply system 110 may supply ammonia to cylinders 90 for combustion. Fuel supply system 110 may include an onboard supply 112 of ammonia, and a control device 116, for example a valve, configured to adjust an amount of ammonia supplied to combustion engine 30. Ammonia may be supplied directly to cylinders 90 or, in some embodiments, first mixed with combustion air directed into an intake manifold 130 of combustion engine 30. It is contemplated that, when a fluid in addition to ammonia is directed into combustion engine 30, fuel supply system 110 may include additional onboard supply and/or delivery devices, if desired.

Exhaust system 120 may include an exhaust manifold 140 connected with cylinders 90. The exhaust produced by combustion engine 30 may be directed from cylinders 90 through exhaust manifold 140 to the atmosphere. Exhaust system 120 may also include one or more exhaust treatment devices in communication with exhaust manifold 140 to treat the exhaust prior to discharge. For example, exhaust system 120 may include a first oxidation catalyst 150, a constituent reducing device 160, and a second oxidation catalyst 170. It is contemplated that exhaust system 120 may include additional or different exhaust treatment devices than shown in FIG. 2, if desired.

First oxidation catalyst 150 may receive exhaust exiting combustion engine 30. The exhaust produced from combusting ammonia may contain NOₓ (such as NO and NO₂). First oxidation catalyst 150 may oxidize NO to convert NO into NO₂, thereby, changing a ratio of NO:NO₂ within the exhaust. In some embodiments, for downstream constituent reducing device 160 to perform optimally, the ratio of NO:NO₂ should be about 1:1. It is contemplated that exhaust system 120 may also include a particulate filter (not shown) configured to reduce particulate matter in the exhaust. If included, the particulate filter may be located upstream or downstream of first oxidation catalyst 150, or may be integrated with first oxidation catalyst 150 to form a single unit.

Constituent reducing device 160 may be configured to reduce a constituent of the exhaust, and may be located downstream of first oxidation catalyst 150. In one embodiment, constituent reducing device 160 may include a selective catalytic reduction (SCR) device configured to reduce NOₓ in the exhaust using a reducing agent, such as ammonia, urea, diesel fuel, etc. Since ammonia may be combusted as a primary engine fuel, it is possible that there is sufficient unburned residual ammonia within the exhaust to reduce NOₓ within the SCR device without additional reductant being injected. Therefore, an injection device normally needed for injecting the reducing agent may be eliminated. In some embodiments, constituent reducing device 160 may be integrated with first oxidation catalyst 150 as a single component.

Second oxidation catalyst 170 may be provided at a downstream end of exhaust system 120, for example, downstream of constituent reducing device 160. Second oxidation catalyst 170 may be configured to oxidize one or more constituents of the exhaust after the exhaust has already been treated by other upstream devices, and before the exhaust is released to the atmosphere. In some embodiments, second oxidation catalyst 170 may be configured to oxidize excess ammonia remaining within the exhaust.

A control system 180 may be associated with exhaust system 120, to regulate operations thereof. Control system 180 may include a controller 190 and a sensor 200 in communication with controller 190. Sensor 200 may be configured to measure an amount of an exhaust constituent within the exhaust, e.g., NOₓ or residual ammonia fuel within the exhaust. Based on signals from sensor 200, controller 190 may adjust control device 116 to change the amount of ammonia supplied to combustion engine 30, thereby controlling constituent emissions in the exhaust.

Controller 190 may be a stand-alone controller or an existing engine control module, and may include a control algorithm for controlling various devices including sensor 200 and control device 116. It is contemplated that controller 190 may be associated with other devices or systems, such as electrical unit 50, if desired.

Sensor 200 may be disposed at any suitable location within exhaust system 120, for example, downstream of constituent reducing device 160 and upstream of second oxidation catalyst 170, or downstream of second oxidation catalyst 170. In some embodiments, sensor 200 may include two separate sensors, a NOₓ sensor configured to measure an amount of NOₓ within the exhaust, and an ammonia sensor configured to measure an amount of ammonia within the exhaust. Sensor 200 may generate a signal indicative of an amount of NOₓ and/or ammonia within the exhaust and may direct the signal to controller 190.

Electrical unit 50 may be powered by combustion engine 30, and may electrically supplement the mechanical power directed from electrical unit 50 to output device 70. Electrical unit 50 may include, among other things, a generator 210, a power storage 220, for example a battery, and an electric motor 230. Generator 210 may be drivingly coupled with combustion engine 30 through a first mechanical link 212, and electrically connected with power storage 220 via a first electrical line 214. Power storage 220 may be further connected with electric motor 230 via a second electric line 224. Electric motor 230 may be mechanically coupled with output device 70 through a second mechanical link 232. Although not shown, it is contemplated that electrical unit 50 may be connected with and regulated by controller 190, if desired.

Transmission 60 may be any suitable (e.g., manual or automatic) transmission known in the art. Transmission 60 may be mechanically coupled with combustion engine 30 to receive mechanical power generated by combustion engine 30 and to transmit the received mechanical power to output device 70 through a plurality of gears, rotating shafts, hydraulic circuits, etc.

### INDUSTRIAL APPLICABILITY

The disclosed ammonia fueled combustion engine and electrical unit may be employed in power system applications where low CO₂ and NOₓ emissions, consistent performance, and low operating cost are desired. Specifically, by combusting ammonia as a primary fuel, extremely low CO₂ emission, or even zero CO₂ emission, may be achieved. NOₓ emissions may also be reduced to a low level by using unburned residual ammonia fuel as a NOₓ-reducing agent in an SCR device, without requiring additional reductant dosing equipment. And, by electrically supplementing mechanical power directed to the power system, the operating range of the power system may be expanded to low load and high speed situations. In addition, because the cost of ammonia as a fuel may relatively be low, substantial savings may be provided by the disclosed power system.

Referring to FIG. 1, power system 20 may generate power to drive machine 10 using combustion engine 30 and electrical unit 50, independently and in combination. Mechanical power may be generated by combustion engine 30 from combustion of ammonia as a primary fuel and may be directed to drive output device 70. Specifically, the generated mechanical power may be transmitted by transmission 60 from combustion engine 30 to output device 70, which may further output the mechanical power to drive load 80 of machine 10.

To help avoid inconsistent combustion due to the low combustion rate of ammonia, the operating range of combustion engine 30 may be controllably limited. That is, combustion engine 30 may be limited to operate within a predetermined engine load range, for example, 30% to 100% of a designed maximum engine load. When a power demand from power system 20 for driving output device 70 is outside of the predetermined engine load range, for example, lower than 30% or higher than 100% of the designed maximum engine load, electrical unit 50 may be used to electrically supplement the mechanical power generated by combustion engine 30. For example, when the power demand of output device 70 is lower than 30% of the designed maximum engine load, combustion engine 30 may still work at 30% of the designed maximum engine load, and the excess power may be absorbed by electrical unit 50 and stored in power storage 220. Combustion engine 30 may be shut down and the demanded power may be provided by power storage 220 through electrical unit 50.

In addition, the engine speed of combustion engine 30 may be limited to help ensure consistent performance of power system 20. For example, the engine speed may be limited to about 6000 r.p.m. When a desired operating engine speed exceeds the predetermined engine speed of combustion engine 30, and/or when a power demand from power system 20 exceeds the mechanical power generated by combustion engine 30, electrical unit 50 may provide additional power to output device 70. Because the mechanical power generated by combustion engine 30 may be electrically supplemented by electrical unit 50 under various operation conditions, issues associated with utilizing ammonia as a primary fuel may be avoided.

Referring to FIG. 2, power system 20 may be driven using only the electrical power provided by electrical unit 50. For example, Machine 10 may be operated in low power conditions, for example, under stop-and-go driving conditions in a city. The power demand from power system 20 in these conditions may be insufficient (e.g., lower than the lowest engine load in the predetermined engine load range) to maintain consistent operation of combustion engine 30, even with the assistance of electrical unit 50. In such conditions, electrical unit 50 alone may provide power to power system 20, and combustion engine 30 may be shut down.

In some operating situations, the power demand from power system 20 may be too high for electrical unit 50 alone to provide power for the demand, but insufficient for combustion engine 30 alone to be operated consistently. In such conditions, combustion engine 30 may still be used to provide power to power system 20, and electrical unit 50 may be used to intentionally increase the engine load on combustion engine 30 by converting a portion of the mechanical power of combustion engine 30 into electrical power. When power storage 220 reaches its full capacity, electrical unit 50 may be turned off, for example, by controller 190. In this manner, electrical unit 50 may help ensure combustion engine 30 is operated at a load condition that is high enough for stable, consistent, and efficient operation.

In some operating situations, the power demand from power system 20 may be large enough for combustion engine 30 to be consistently and efficiently operated without assistance from electrical unit 50. That is, the load on combustion engine 30 may be within the predetermined engine load range. Under such conditions, combustion engine 30 alone may provide power to power system 20.

In some operating conditions, the power demand from power system 20 may exceed the mechanical power capacity of combustion engine 30. In such conditions, electrical unit 50 may provide additional power to power system 20. Thus, combustion engine 30 and electrical unit 50 may simultaneously provide power to power system 20 for driving machine 10.

Controller 190 may control the air/fuel ratio of combustion engine 30 by adjusting, for example, the amount of ammonia fuel directed through control device 116. An amount of ammonia fuel in excess of a stoichiometric amount (i.e., equivalence ratio greater than 1.0) may be supplied to combustion engine 30, such that residual ammonia fuel is present within the exhaust. The residual ammonia fuel may be used as a reductant for reducing NOₓ within constituent reducing device 160. At constituent reducing device 160, the residual ammonia fuel may react with NOₓ to convert NOₓ to nitrogen and water. Controller 190 may analyze the amount of NOₓ, the amount of ammonia, or both measured by sensor 200, and responsively adjust the amount of ammonia fuel supplied to combustion engine 30. With such a feedback system, NOₓ and ammonia emissions to the atmosphere may be controlled to be below a predetermined level.

It will be apparent to those skilled in the art that various modifications and variations can be made to the power system of the present disclosure without departing from the scope of the disclosure. Other embodiments will be apparent to those skilled in the art from consideration of the specification and practice of the power system disclosed herein. It is intended that the specification and examples be considered as exemplary only, with a true scope of the disclosure being indicated by the following claims and their equivalents.

What is claimed is:

1. A power system, comprising:
an output device;
a combustion engine configured to combust ammonia as a primary fuel to generate mechanical power directed to the output device; and
an electrical unit configured to supplement the mechanical power directed to the output device.

2. The power system of claim 1, wherein the combustion engine is configured to combust ammonia as the only fuel to generate the mechanical power directed to the output device.

3. The power system of claim 1, wherein the electrical unit is configured to supplement the mechanical power when a power demand from the power system is outside of a predetermined engine load range.

4. The power system of claim 1, wherein the electrical unit is configured to supplement the mechanical power when a desired operating engine speed of the combustion engine exceeds a predetermined engine speed.

5. The power system of claim 1, wherein the electrical unit includes at least one of a power storage, a generator, or an electric motor.

6. The power system of claim 1, further including:
a sensor configured to measure at least one of an amount of NOₓ or an amount of residual ammonia fuel within exhaust produced by the combustion engine; and
a controller configured to adjust an amount of ammonia supplied to the combustion engine as the primary fuel based on at least one of the measured amount of NOₓ or residual ammonia fuel.

7. The power system of claim 1, further including a constituent reducing device configured to use residual ammonia fuel within exhaust produced by the combustion engine to reduce a constituent of the exhaust.

8. The power system of claim 7, wherein the constituent reducing device includes a selective catalytic reduction device.

9. The power system of claim 7, wherein the constituent of the exhaust is NOₓ.

10. The power system of claim 1, wherein the electrical unit is configured to increase an engine load of the combustion engine when a power demand from the power system is insufficient to maintain consistent operation of the combustion engine.

11. A method of operating a power system, comprising:
combusting ammonia as a primary fuel to generate mechanical power directed to drive the power system; and
electrically supplementing the mechanical power directed to drive the power system.

12. The method of claim 11, further including:
converting a portion of the mechanical power into electrical power; and
directing the electrical power to supplement the mechanical power directed to drive the power system.

13. The method of claim 11, further including:
supplying ammonia fuel in excess of a stoichiometric amount into the power system; and
reducing a constituent of the exhaust using residual ammonia fuel within the exhaust.

14. The method of claim 11, further including:
measuring at least one of an amount of an exhaust constituent or an amount of residual ammonia fuel within the exhaust; and
adjusting an amount of ammonia fuel supplied to the power system based on the at least one of the measured amount of the exhaust constituent or the measured amount of the residual ammonia fuel within the exhaust.

15. The method of claim 11, wherein electrically supplementing the mechanical power includes electrically supplementing the mechanical power when a power demand from the power system is outside of a predetermined engine load range.

16. The method of claim 11, wherein electrically supplementing the mechanical power further includes electrically supplementing the mechanical power when a desired operating engine speed exceeds a predetermined engine speed.

17. The method of claim 11, wherein combusting ammonia as the primary fuel includes combusting ammonia as the only fuel.

18. The method of claim 11, further including increasing an engine load by converting mechanical power generated from combusting ammonia into electrical power when a power demand from the power system is insufficient to sustain consistent combustion of the ammonia.

19. A machine, comprising:
a traction device configured to propel the machine;
an onboard supply of ammonia fuel;
a combustion engine configured to combust the ammonia fuel as a primary fuel and generate mechanical power directed to the traction device;
an electrical unit powered by the combustion engine to electrically supplement the mechanical power directed to the traction device; and
a constituent reducing device configured to use residual ammonia fuel from exhaust exiting the combustion engine to reduce a constituent of the exhaust.

20. The machine of claim 19, wherein the electrical unit is configured to supplement the mechanical power when a power demand from a power system is outside of a predetermined engine load range, or when a desired operating engine speed exceeds a predetermined engine speed.
